(19) United States
(12) Patent Application Publication
(10) Pub. No.: US 2023/0001558 A1
(43) Pub. Date: Jan. 5, 2023

(54) Tool With Hammer Claw Anchor

(71) Applicant: Francisco Orine, Imperial, MO (US)

(72) Inventor: Francisco Orine, Imperial, MO (US)

(21) Appl. No.: 17/832,760

(22) Filed: Jun. 6, 2022

Related U.S. Application Data
(60) Provisional application No. 63/217,476, filed on Jul. 1, 2021.

(51) Int. Cl. B25C 11/00; B25F 1/00

(52) U.S. Cl. CPC B25C 11/00; B25F 1/006

(57) ABSTRACT

A tool with a hammer claw anchor includes a tool having a body and at least one working end. The working end may have a pair of jaws. At least one anchor is affixed to the tool body. The anchor is adapted to engage with a hammer claw. The hammer claw is utilized to create a second lever arm and impart additional force to the leverage tool in the instance where greater forces than what can be achieved with the single lever arm of the leverage tool are required.

### CROSS REFERENCE TO RELATED APPLICATIONS

This application claims the benefit of U.S. Provisional Application No. 63/217,476 filed on Jul. 1, 2021. The above identified patent application is herein incorporated by reference in its entirety to provide continuity of disclosure.

### BACKGROUND OF THE INVENTION

The present invention relates to a tool for applying leverage, such as a prybar or similar leverage tool, for example. More specifically, the present invention provides a leverage tool that includes hammer claw anchors that can removably engage a hammer claw or similar structure, such that a hammer or similar tool can provide additional leverage and impart greater force to the leverage tool.

Tools such as pry bars, crowbars, and the like are utilized for various tasks that require a force to be imparted to a work surface or object. One common use for such tools is as a simple lever to impart force to an area. The simple lever may be used for demolition projects, for lifting or otherwise repositioning heavy objects, or for many other tasks. To apply leverage, the working end of the pry bar, crow bar, or other leverage tool acts as a fulcrum, while the elongated portion of the leverage tool acts as a lever arm as the user applies force to the handle end of the leverage tool. The lever action allows a greater force to be imparted than what a person could accomplish without the use of such a tool.

While leverage tools are useful for applying force to an object or area, they are not without their drawbacks, and require improvement. For example, there are scenarios where a user along is not able to apply enough force alone, even with the additional leverage provided by the pry bar or other leverage tool, to accomplish a particular task. For example, very hard-stuck fasteners or materials that must be removed may require a greater amount of force be imparted for their removal. An individual may not be able to impart this force with their strength and body weight alone, and may need additional help to apply greater force, which is not always available. In order to address these concerns, the present invention provides a leverage tool that includes a hammer claw anchor, which allows a hammer claw or similar item to grasp the leverage tool. The hammer can then be utilized as a second lever arm that acts on the first lever arm of the leverage tool, allowing a single user to impart a greater amount of force to complete their task.

In light of the devices disclosed in the known art, it is submitted that the present invention substantially diverges in design elements from the known art and consequently it is clear that there is a need in the art for an improvement to existing leverage tools such as prybars and crowbars, particularly due to the common need to impart additional force to the tool. In this regard the present invention substantially fulfills these needs.

### SUMMARY OF THE INVENTION

In view of the foregoing disadvantages inherent in the known types of leverage tools now present in the prior art, the present invention provides a tool with a hammer claw anchor, wherein the same can be utilized to provide an optional second lever arm for imparting greater force to the tool as needed.

In general, the tool includes a body having a first end and a second end. A first tool head is disposed on the first end of the body. A second tool head may be disposed on the second end of the body. At least one anchor is affixed to the body. The anchor is adapted to engage a slot of a hammer claw, such that the hammer can be utilized to impart greater forces by acting as a second lever arm. There may be a pair of anchors to provide additional attachment points, allowing additional leverage to be applied no matter the current angle or positioning of the tool. In some embodiments, the tool includes a first tool head having a first pair of jaws disposed on the first end of the body and a second tool head having a second pair of jaws disposed on the second end of the body. A first pair of anchors is affixed to the first end of the body and a second pair of anchors is affixed to the second end of the body. The first pair of anchors are positioned on a first pair of opposing sides of the body and the second pair of anchors are positioned on a second a pair of opposing sides of the body, such that the first pair of anchors align with the first pair of jaws, and such that the second pair of anchors align with the second pair of jaws. This particular orientation ensures that leverage can be applied effectively no matter which end of the tool is being used as the active working end or first lever arm.

Other objects, features, and advantages of the present invention will become apparent given the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings.

FIG. 1 shows a perspective view of a first embodiment of the tool with hammer claw anchor.

FIG. 2 shows a perspective view of a first embodiment of the tool with hammer claw anchor in use.

FIG. 3 shows a perspective view of a first embodiment of the tool with hammer claw anchor in use.

FIG. 4 shows a perspective view of a second embodiment of the tool with hammer claw anchor.

FIG. 5 shows a perspective view of a third embodiment of the tool with hammer claw anchor.

FIG. 6 shows a perspective view of a third embodiment of the tool with hammer claw anchor in use.

FIG. 7 shows a perspective view of a third embodiment of the tool with hammer claw anchor in use.

### DETAILED DESCRIPTION OF THE INVENTION

Reference is made herein to the attached figures. For the purposes of presenting a brief and clear description of the present invention, the preferred embodiment will be discussed as used for providing a tool with a hammer claw anchor that can be utilized as an attachment point for imparting additional leverage to the tool with a hammer or the like. The figures are intended for representative purposes only and should not be considered to be limiting in any respect.

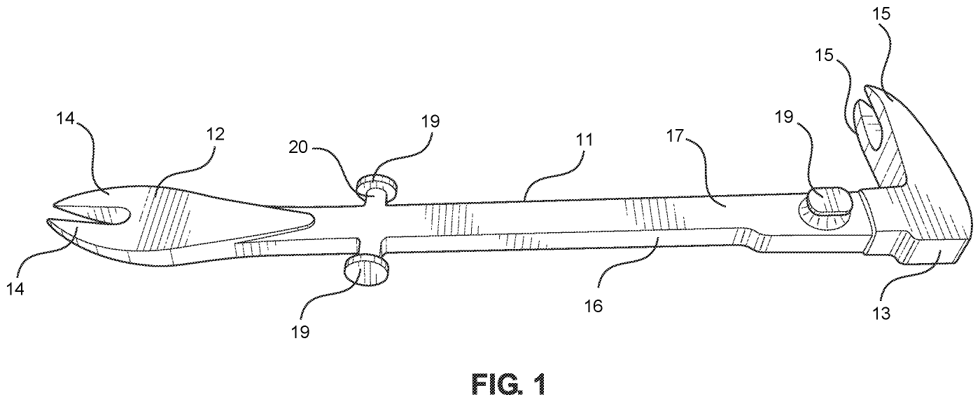

Referring now to FIG. 1, there is shown a perspective view of a first embodiment of the tool with hammer claw anchor. In general, the tool includes a body 11 having a first end and a second end. The first end comprises a first tool head 12, such that the tool includes at least one working end. In the shown embodiment, the first tool head 12 includes a pair of spaced jaws 14 defining a central opening therebetween. In the shown embodiment, the tool further includes a second tool head 13 having a second pair of jaws 15 disposed on the second end of the body 11, which differs in structure and positioning from the first tool head 12 in order to provide additional uses for the tool. For example, the first tool head 12 extends in-line with the body 11, while the second tool head 13 extends perpendicularly outwardly from the opposing second end of the body 11. This imparts additional utility to the tool and allows the tool to be used at various angles and for various purposes. In other embodiments, the tool heads 12, 13 can have different shapes and configurations, and the overall shape and structure of the body portion can vary.

At least one anchor 19 is affixed to the body. Each anchor 19 is adapted to engage a slot of a hammer claw. In the shown embodiment, a first pair of anchors 19 are affixed to the first end of the body 11, and a second pair of anchors 19 are affixed to the second end of the body 11. The first pair of anchors 19 are positioned on a first pair of opposing sides 16 of the body 11 and the second pair of anchors 19 are positioned on a second a pair of opposing sides 17 of the body 11, such that the first pair of anchors 19 align with the first pair of jaws 14, and such that the second pair of anchors 19 align with the second pair of jaws 15. In this way, two pairs of anchors 19 are formed, with one pair of anchors 19 oriented perpendicularly to the other pair of anchors 19. In this way, the user has many mounting points to apply leverage as needed and increase force in a particular direction.

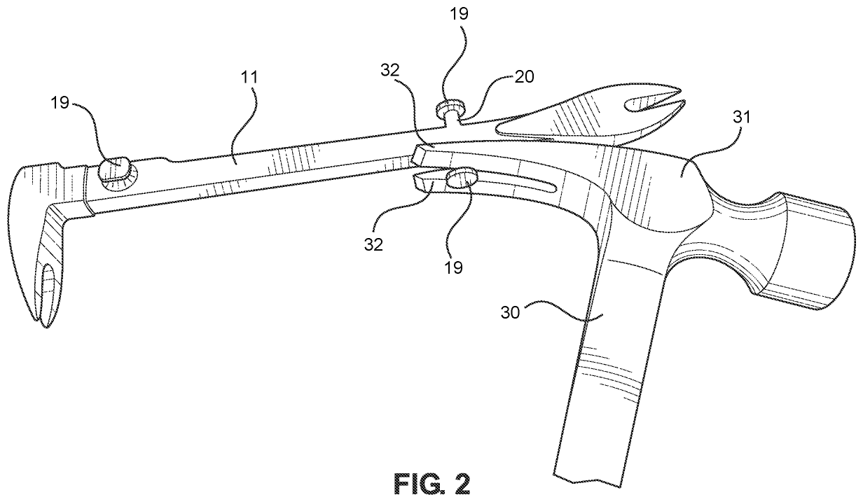

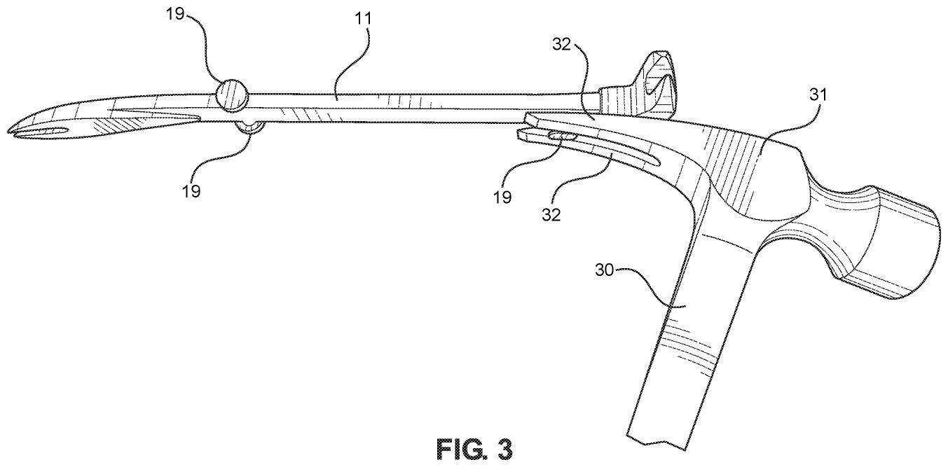

Referring now to FIGS. 2 and 3, there are shown perspective views of a first embodiment of the tool with hammer claw anchor in use. The tool 11 is being utilized with additional leverage being applied by a hammer 30, which has a hammer claw 32 on the rear portion of the hammer head 31. In the shown embodiment, each anchor 19 includes a tab affixed to an outer end of a post 20, such that the tab provides an engagement surface which contacts the hammer claw 32, similar to when a hammer claw 32 is utilized to pull out a nail fastener. The tab 19 is shown to be rounded or circular, but the tab 19 may include any suitable shape.

While a hammer claw 32 is utilized here, other similar tools that can engage the post and tab elements of the anchor 19 can be utilized. In operation, the user can use whichever end of the tool is suitable for a current task that requires an application of leverage to increase the force the user can impart on a workpiece. Depending on the orientation of the tool head that is being use, one of the anchors 19 should be facing in a desired direction and in an appropriate location along the length of the tool. The operator can select an anchor 19 to engage with the hammer claw 32, which can engage the post 20 and tab of the anchor 19 similar to how the hammer claw would engage a hardware nail for removal. This allows the user to essentially select the fulcrum or moment arm for a second lever arm. In this way, the user can selectively use the hammer claw to apply additional leverage as needed. Afterward, the user can simply remove the hammer claw from the anchor 19.

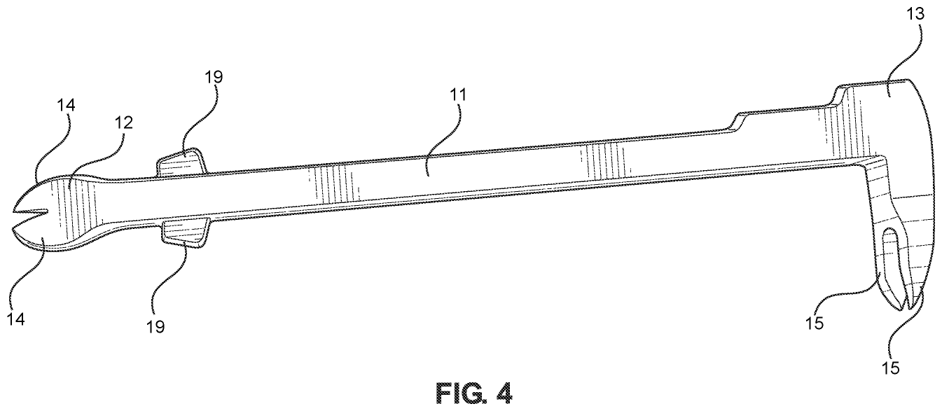

Referring now to FIG. 4, there is shown a perspective view of a second embodiment of the tool with hammer claw anchor. In this embodiment, each anchor 19 comprises a tab that is integrally formed with the body. The tab is tapered, such that each anchor 19 comprises a first end with a first height that tapers inwardly to a second end with a second height that is lower than the first height. This configuration provides an ideal engagement surface for a hammer claw or similar object. In the shown embodiment, the anchors 19 are positioned on the end of the tool body 11 opposite the second, perpendicular tool head 13, which also includes a pair of jaws 15 for additional utility. This allows the first, parallel tool head 12 to be utilized as a handle end while applying leverage to the perpendicular second tool head 14 for prying or similar actions. The hammer claw can then be used with the anchors 19 at the handle end to provide additional leverage as needed.

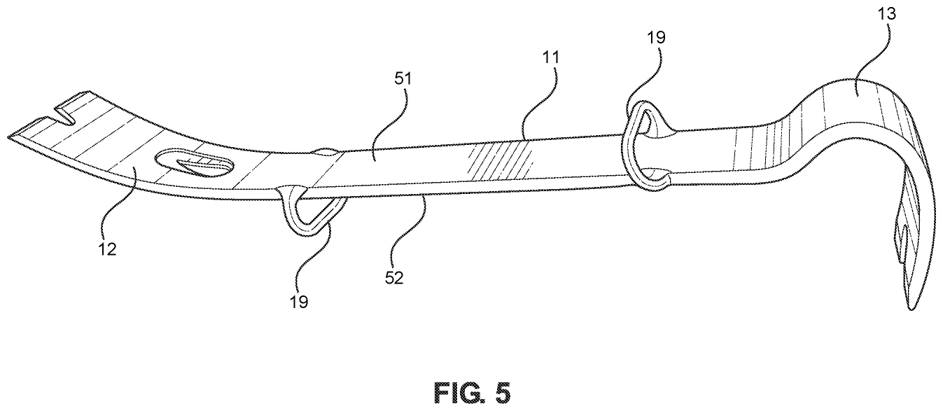

Referring now to FIG. 5, there is shown a perspective view of a third embodiment of the tool with hammer claw anchor. In this embodiment, the anchors 19 include a rod that has opposing ends affixed to opposing side edges of the body 11, forming a loop that receives the hammer claw. The shown embodiment includes a pair of anchors 19, with one extending from a first side 51 of the body 11 and the other extending from a second side 52 of the body. This provides additional mounting points for applying leverage with the hammer claw when either tool head 12, 13 is utilized.

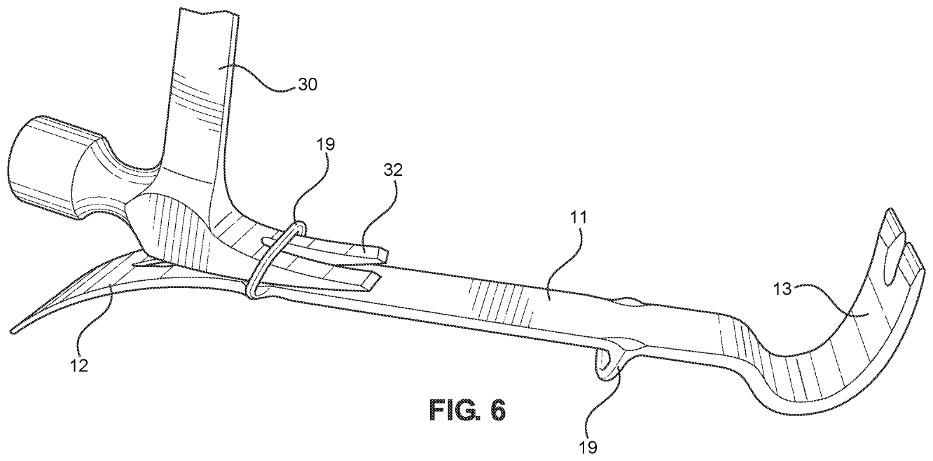

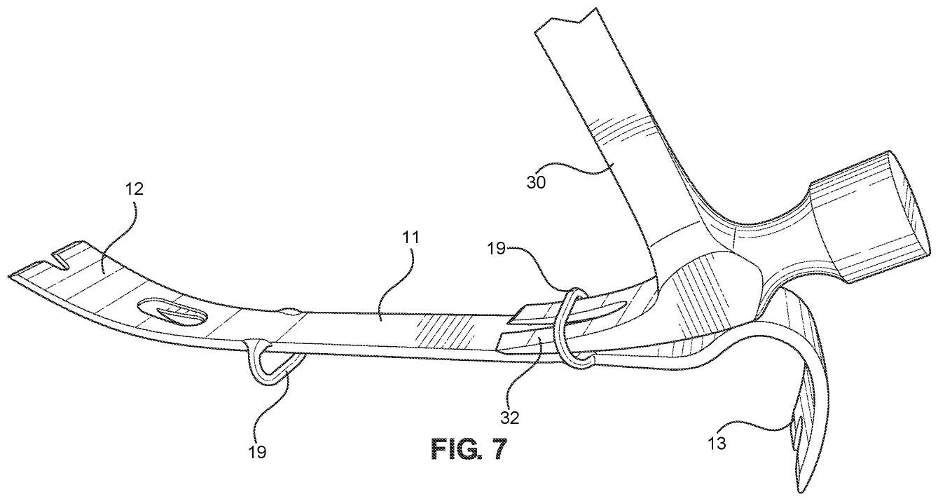

Referring now to FIGS. 6 and 7, there is shown a perspective view of a third embodiment of the tool with hammer claw anchor in use. In this embodiment, the hammer's 30 claw 32 is inserted through the loop defined by the anchor 19, such that the rod retains the hammer claw 32 and contacts the lower side of the hammer claw 32. In the shown embodiment, the two tool heads 12, 13 have opposite curvature so either end can be utilized depending on the surface or other operational considerations. The two anchors 19 are positioned such that leverage can be applied by the hammer claw 32 no matter which end of the tool is being utilized. In this way, the user has multiple options for applying additional leverage and can select both the first lever arm and second lever arm depending on the task being completed.

It is therefore submitted that the present invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A tool, comprising:
a body having a first end and a second end;
a first tool head disposed on the first end of the body;
at least one anchor affixed to the body;
wherein the at least one anchor is adapted to engage a slot of a hammer claw.

2) The tool of claim 1, wherein the first tool head comprises a pair of jaws defining a first opening.

3) The tool of claim 1, further comprising a second tool head disposed on the second end of the body.

4) The tool of claim 3, wherein the second tool head comprises a second pair of jaws defining a second opening.

5) The tool of claim 3, wherein the second tool head is oriented perpendicular to the first tool head.

6) The tool of claim 1, wherein the anchor comprises a tab affixed to a post that extends outwardly from the body of the tool.

7) The tool of claim 1, wherein the at least one anchor comprises a tab having a first end with a first height that tapers inwardly to a second end with a second height that is lower than the first height.

8) The tool of claim 1, wherein the at least one anchor is integrally formed with the body of the tool.

9) The tool of claim 7, wherein the at least one anchor comprises a pair of anchors.

10) The tool of claim 1, wherein the at least one anchor comprises a rod affixed to opposing sides of the body, forming a loop that receives the hammer claw.

11) A tool, comprising:
a body having a first end and a second end;
a first tool head comprising a first pair of jaws disposed on the first end of the body;
a second tool head comprising a second pair of jaws disposed on the second end of the body;
a first pair of anchors affixed to the first end of the body;
a second pair of anchors affixed to the second end of the body;
wherein the first pair of anchors are positioned on a first pair of opposing sides of the body and the second pair of anchors are positioned on a second a pair of opposing sides of the body, such that the first pair of anchors align with the first pair of jaws, and such that the second pair of anchors align with the second pair of jaws;
wherein the anchors of the first pair of anchors and the anchors second pair of anchors are adapted to engage a slot of a hammer claw.

12) The tool of claim 11, wherein the second tool head is oriented perpendicular to the first tool head.

13) The tool of claim 11, wherein each anchor comprises a tab affixed to a post that extends outwardly from the body of the tool.

14) The tool of claim 11, wherein each anchor comprises a tab that is integrally formed with the body.

15) The tool of claim 14, wherein each tab comprises a first end with a first height that tapers inwardly to a second end with a second height that is lower than the first height.
